(19) United States
(12) Patent Application Publication
(10) Pub. No.: US 2006/0105084 A1
(43) Pub. Date: May 18, 2006

(54) Packaged pet food of novel appearance

(75) Inventor: Iain Fee, Wodonga (AU)

Correspondence Address: FULBRIGHT & JAWORSKI, LLP, 1301 MCKINNEY, SUITE 5100, HOUSTON, TX, 77010-3095, US

(73) Assignee: Mars Incorporated, Mclean, VA (US)

(21) Appl. No.: 10/535,122

(22) PCT Filed: Nov. 18, 2003
(86) PCT No.: PCT/AU03/01543

§ 371 Date: Jul. 25, 2005

(30) Foreign Application Priority Data
Nov. 18, 2002 (AU) 2002952713

(51) Int. Cl. A23B 7/148

(52) U.S. Cl. 426/106

(57) ABSTRACT

Disclosed is a packaged pet food product that includes one or more solid food components in a sauce or gel, wherein said solid food components are placed separately in a package having a single cavity for receiving pet food material, and wherein said solid food components are maintained in visually discrete groups within said cavity.

### TECHNICAL FIELD

The invention relates to the field of commercial pet food manufacture. In particular it relates to packaged pet food products that have a novel and desirable visual function.

### BACKGROUND OF THE INVENTION

Food manufacturers, including commercial canned pet food manufacturers, are continuously challenged to find ways to present an appetizing and authentic food product at minimized raw material costs. A product format of particular popularity for its ability to evoke the aesthetics of a human food casserole is the ‘chunks in sauce’ format. This involves chunks of solid food material, including meat, or more commonly meat analogue, and optionally including vegetable material, either in runny gravy or in a solid or semi-solid gel. The gravy or gel may be transparent or opaque.

The aesthetic desirability of such products depends greatly on the appearance of the analogue material—its size, shape, texture etc., and any other food materials included. For example, the inclusion of vegetable material provides both ‘real food’ aesthetic cues to the pet foods, as well as a variety of food color and particle size that gives the overall pet food product a heightened aesthetic appeal.

However, to date the design and manufacture of such products has meant that the visual impact of such ingredients has not been maximized. Generally, these products are formed by the blending together of the gravy material and the solid food materials in a mixer, followed by filling this blend into the package, whether that be a traditional cylindrical steel can, a square aluminum or plastic tray or any other suitable form of packaging.

As defined herein, packaged pet foods include those in cans, trays (aluminum, plastic, etc), pouches and similar rigid or semi-rigid containers suitable for holding moist and semi-moist food products, including liquid gravies.

As the aesthetic impact of such foods is most directly observed immediately upon opening the package, it becomes necessary to include sufficient of the most visually effective components in the mix in very high proportions in order to ensure that there will be a sufficiently visible presence of these components at the upper surface of the package. As these components, such as the vegetables, are often the most costly parts of the product, it is clear that the pet food manufacturer does not obtain maximum product aesthetic value for the relative formulation cost expended on these materials.

In addition, as the pet food must be blended in commercial scale food mixers, such as ribbon- or paddle-blenders, each of the solid food components must be sufficiently robust to survive the shear and compression forces that tend to be applied to materials in such operations. This tends to preclude the use of more aesthetically pleasing component designs, such as relatively thin slices of meat or meat analogue, as they also tend to be more susceptible to degradation during mixing.

Therefore, it is desired to develop product formats that overcome these constraints and enhance presentation of the food product. In the prior art relating to human food, it is known to provide ‘compartmented’ packages, e.g. the familiar ‘TV-dinner’ type presentation, where individual ingredient are filled into individual compartments in the package. Another example are the ‘breakfast yoghurt’ packages, where the moist yoghurt is compartmented separately from e.g. dry ingredients such as nuts, to avoid moisture degradation of the dry ingredients during storage. The consumer is then required to mix the two components together before use.

However, such formats are typically not applicable to commercial pet food production, as the packaging materials themselves are often too costly to be commercially feasible in such a low-cost base market segment. Equally, where the pet owner is really looking for a human-style ‘casserole’ product, where all of the components are cooked together, the desire is for a high level of convenience in food handling. Consequently, the pet owner will not favor a product format that requires inconvenient mixing prior to feeding to the animal.

### BRIEF SUMMARY OF THE INVENTION

Therefore, it is an object of the present invention to provide a premium packaged pet food product that maximizes the visual impact of its high-cost components while allowing easy dispensing of the food by the pet owner.

According to one aspect of the invention, there is provided a packaged pet food product that includes one or more solid food components in a sauce or gel, wherein said solid food components are placed separately in a package having a single cavity for receiving pet food material, and wherein said solid food components are maintained in visually discrete groups within said cavity.

The advantage of this presentation is that where, for example, one of the components consists of diced vegetables, the diced vegetables are not obscured by the other component or components.

A further advantage of the invention is that as the components are not physically blended, it is possible to utilize more delicate ingredients in the pet food.

A still further advantage of the invention over the prior art is that as the components are held within the same cavity in the package, there is no need to separately mix the ingredients together prior to package filling.

An added benefit of this arrangement over the compartmentalized prior art is that where one of the components is relatively less palatable than another component, the flavors of the more palatable component will tend to infuse the less palatable component, thereby improving its palatability and reducing the likelihood that it will be ‘left behind’, as may happen with e.g. vegetables.

Advantageously, the package will be a relatively flat can or tray, thereby providing greater surface area per unit pet food volume, maximizing the visual impact of each of the components. Preferably, the package has a width to depth ratio of at least 3:1.

In a particularly preferred embodiment, there is included a first solid food component that is a meat or meat analogue food product, and further solid food components selected from a group including vegetables, rice and pasta. The meat or meat analogue product may include poultry, beef, pork, fish etc, a sauce or gel serving to embed the meat pieces in a savory matrix. The same sauce may also be used to moisten the other solid food pieces, or alternatively a differently flavored sauce or gel may be used.

The sauce or gel incorporated in the pet food product may be based on any one of a number of materials that are well known in the art for this purpose, including but not limited to gelatinized starches such as waxy maize starch, hydrated gums such as carrageenan, locust bean and xanthan, or other materials such as agar agar. Dairy based sauces may also find use.

The nature of the invention will be further explained using a specific, non-limiting example of a canned pet food product of superior aesthetic appeal and which is in accordance with the invention.

### BRIEF DESCRIPTION OF THE DRAWINGS

FIG. 1 is a schematic flow diagram of a process for preparing a proteinaceous meat analogue.

### DETAILED DESCRIPTION OF THE INVENTION

Firstly, a beef steak analogue product was prepared. The overall formulation of the product is given in Table 1.

TABLE 1

| Ingredient | mass % |
|---|---|
| Fibrous Proteinaceous | 40 |
| Extruded Chunk | |
| Mechanically De-boned | Approx. |
| Chicken Meat (MDM) | 50 |
| Binders, | 3 |
| Water | 7 |
| Red Iron Oxide | 0.02 |

The fibrous extruded material was obtained as per the formulation and process described in WIPO patent document no. WO 00/69276 by Effem Foods Pty Ltd. For this application, it was shredded to an approximate size corresponding to the ranges: height range from 0.5-10 mm, width range from 5-30 mm, length range from 20-80 mm.

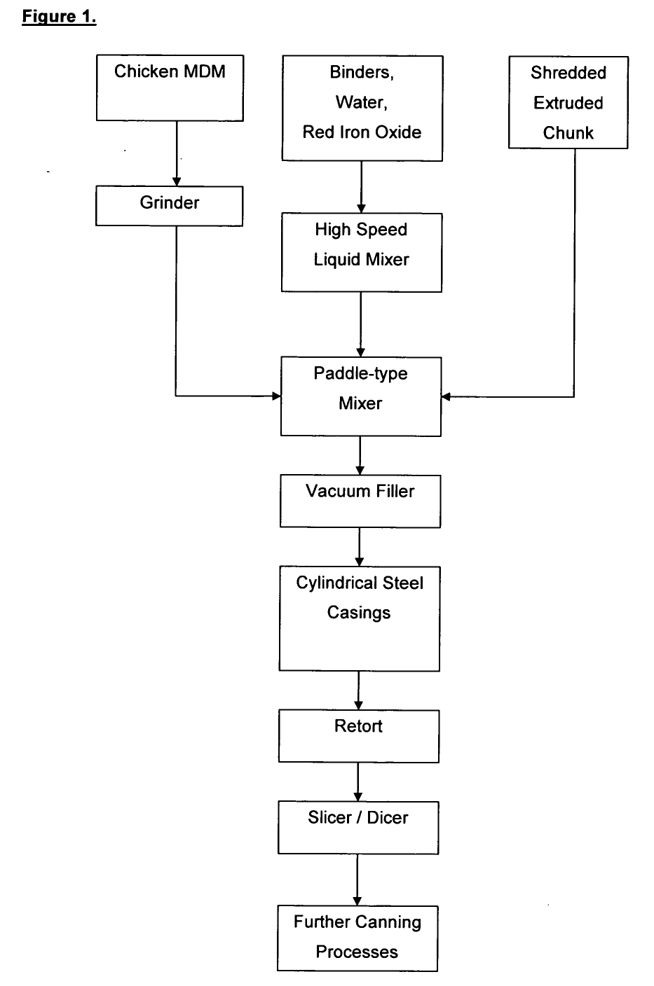

The analogue was prepared according to the process flow shown in FIG. 1. Firstly, the water, binders and red iron oxide are mixed in a high-speed liquid mixer. The binders serve to hold the structure of the analogue together, while red iron oxide provides an authentic color to the analogue. The chicken MDM was ground in a Weiler-type meat grinder having a hole plate size in the range 2-10 mm.

Then the mixed liquid, the ground meat and the extruded material were transferred to a horizontal paddle blender and mixed until relatively homogeneous.

This mixture was then filled into steel casings, preferably having a rectangular cross-section of about 50 mm by 100 mm. It will be appreciated by those skilled in the art that any desirable shape and size may be used. The filling was accomplished via a vacuum filler of the type commonly used in small goods manufacturing. The filled and sealed casings were placed on retort racks and thermally processed in a retort at a temperature of 95° C. for approximately 60 minutes. The thermal processing causes the protein matrix present in the mix to denature and thereby bind the extruded chunk. The thermal processing also tends to reduce the likelihood that further material will be expressed by the analogue as it is further processed during the sterilization of the canned products in which it is to be included, causing ‘cook-out’ cloudiness in the sauce.

After thermal processing, and optional chilled storage, the casing was removed and the analogue material was cut to a size of on average 22 mm width, 48 mm length and 4 to 5 mm. These slices were collected in stacks of seven. These stacks were then rolled back at an angle of approximately 45°, in order to present the appearance from above of mutually overlapping layers of sliced meat, as per the slices of a sliced loaf of bread that are allowed to fall over by gravity, i.e. a shingle-like, stacked appearance.

These ‘shingled’ stacks were then picked up and placed into an aluminum retort tray of approximately square shape. The approximate size of the tray is 85 mm×85 mm×25 mm. The approximate mass of meat analogue added to the tray is approximately 35-45 g. The arrangement and placing of the meat analogue is such that it covers approximately 75% of the area of the tray base. This meat analogue material formed the first solid food component of the pet food product, and was placed in the tray such that it covered a single, continuous, predetermined area of the base of the tray, while leaving the remainder of the base of the tray as a continuous uncovered portion.

Vegetable material was then added to the remaining 25% uncovered portion of the tray base. This vegetable material formed the second solid food component according to the invention. This component provided nutritional cues and further enhanced the appearance of the product. This vegetable material was diced to approximately 6 mm×6 mm×6 mm, and was selected to include solely or commingled carrot, roma beans, yellow capsicum, broccoli and potato. Other suitable vegetable materials may be used if desired. The total vegetable inclusion in the tray was approximately 7% by mass.

Separately, gravy was prepared having a composition given in Table 2.

TABLE 2

| Ingredient | mass % |
|---|---|
| Tapioca Starch | 3.1 |
| Guar gum | 0.8 |
| Water | 96.1 |

This gravy was made up in a high speed liquid mixer of the kind very well-known in the art. This gravy was then added to the tray to make up the mass of product to approximately 100 g.

The tray was then sealed and retorted to achieve commercial sterility.

Upon opening, both the overlapping meat analogue slices, resembling premium steak that has been carefully sliced and carefully placed in the tray, and the diced vegetable material were immediately obvious and visually impressive, giving the overall product a highly pleasing and appetizing appearance that is prized by the customers of premium pet food products. It will be noted by those skilled in the art that vegetable inclusion levels of 10-15% by mass are normally too low to provide such an aesthetic appearance in prior art pet food product formats, e.g. casserole-style products and that relatively thin slices of meat analogue material would typically be severely degraded if such were included in the mixture filled into a can using known filling equipment.

It will be appreciated by those skilled in the art that other specifically arranged pet food products, having a wide variety of configurations of meat and other inclusions, may be produced in accordance with the invention.

1. A packaged pet food product comprising:
two or more solid food components in a sauce or gel, wherein said solid food components are placed separately in a relatively flat can or tray having a single cavity for receiving pet food material, and wherein said solid food components are maintained in visually discrete groups within said cavity.

2. The pet food product of claim 1, wherein said can or tray has a width to depth ratio of at least 3:1.

3. The pet food product of claim 1, further comprising a first solid food component that is a meat or meat analogue food product substantially derived from one or more materials selected from a group consisting of bovines, ovines, porcines, poultry and fish; and one or more further solid food components selected from a group consisting of vegetables, rice and pasta.

4. The pet food product of claim 3, wherein said solid components are surrounded by a sauce or gel serving to embed the meat pieces in a savoury matrix.

5. The pet food product of claim 4, wherein said gel or sauce contains flavoring agents.

6. The pet food product of claim 4, wherein said gel or sauce is substantially comprised of water and one or more materials selected from a group consisting of starch, vegetable gums and agar agar.

7. A method of producing a packaged pet food product, the method comprising the steps of:
providing a package in the shape of a relatively flat can or tray, and having a single cavity for receiving pet food material; and
placing solid food components separately in visually discrete groups within said cavity.

8. The method of claim 7, wherein said packaged pet food product includes two or more solid food components in a sauce or gel, wherein one solid food component is a meat or meat analogue food product substantially derived from one or more materials selected from a group consisting of bovines, ovines, porcines, poultry and fish; and one or more further solid food components are selected from a group consisting of vegetables, rice and pasta.

9. (canceled)

10. (canceled)
